(19) United States
(12) Patent Application Publication
(10) Pub. No.: US 2005/0188211 A1
(43) Pub. Date: Aug. 25, 2005

(54) IP for switch based ACL's

(76) Inventors: Steven J. Scott, Brookfield, WI (US); David D. Brandt, Milwaukee, WI (US)

Correspondence Address: Susan M. Donahue;Rockwell Automation, 704-P, IP Department, 1201 South 2nd Street, Milwaukee, WI, 53204, US

(21) Appl. No.: 10/842,289

(22) Filed: May 10, 2004

Related U.S. Application Data
(60) Provisional application No. 60/546,116, filed on Feb. 19, 2004.

(51) Int. Cl. H04K 1/00

(52) U.S. Cl. 713/183

(57) ABSTRACT

A system that facilitates protecting an internal network from internal attacks comprises an entity that requests access to the internal network, wherein the internal network includes a plurality of items. A multi-layered security component determines that the entity is authorized to access the internal network, and restricts access of the entity to a subset of the items. In accordance with one aspect of the present invention, a switch can be employed to restrict access of the entity to a subset of the items.

### REFERENCE TO RELATED APPLICATION

This application claims the benefit of U.S. Provisional Application Ser. No. 60/546,116 filed on Feb. 19, 2004, and entitled IP FOR SWITCH BASED ACL'S, the entirety of which is incorporated herein by reference.

### TECHNICAL FIELD

The present invention relates generally to securing internal networks from internal threats, and more particularly to securing internal networks from internal threats via providing a multi-layered security system that facilitates restricting access to particular entities to a portion of an internal network.

### BACKGROUND OF THE INVENTION

Due to advances in computing technology, businesses today are able to operate more efficiently when compared to substantially similar businesses only a few years ago. For example, internal networking enables employees of a company to communicate instantaneously by email, quickly transfer data files to disparate employees, manipulate data files, share data relevant to a project to reduce duplications in work product, etc. Accordingly, maintaining security of internal networks is a high priority. As reliance upon these internal networks continue to grow, protecting digital assets within these networks will become even more important. For example, immeasurable damage would result if a malicious hacker obtained access to an internal network and destroyed/altered important and/or sensitive data within the network. Accordingly, numerous security mechanisms have been developed to combat external attacks on data resident upon an internal network.

Similar advances in security of internal networks, however, have not occurred with respect to internal attacks on an internal network. For example, a disgruntled employee can have access to an entire network (e.g., including portions of a network completely unrelated to the employee's employment). More particularly, an engineer within a business can have access to a portion of an internal network that includes payroll data, even though the engineer's employment is not related to maintaining/providing payroll information. Furthermore, as typical internal networks utilize dynamically allocated IP addresses, any individual with a laptop or other computing device can connect to a network port and have complete network access. Portions of an internal network can be provided with password protection, thereby allowing only those who know the password to have access to that portion of the internal network. Passwords, however, are easily compromised. For example, they can be overheard, written on a piece of paper and misplaced, determined by a hacker, etc.

A small number of larger businesses have employed internal firewalls and Demilitarized Zones to facilitate securing their internal networks. These devices, however, are typically only utilized to filter service points (e.g., they do not discriminate against a source of a request for data on the network). This is because most larger businesses have employees positioned geographically and not by function (e.g., a large automobile company does not place all its engineers in one location). Thus, there still remains an issue of individuals having access to portions of an internal network that are not related to their employment function(s).

Accordingly, there exists a strong need in the art for a system and/or methodology that facilitates robust protection of an internal network from internal attacks.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention facilitates securing an internal network from internal attacks without costs and drawbacks associated with applying multiple firewalls to an internal network. The present invention utilizes a multi-layered security concept to limit access to resources within an internal network. More particularly, the present invention provides a system and/or methodology for determining whether an entity is authorized to access an internal network, where an entity can be a user, a client, a program, or the like. Furthermore, various authentication standards and/or protocols can be employed to determine whether an entity is authorized to access the internal network. In accordance with one aspect of the present invention, the 802.1x standard of authentication can be utilized to determine whether an entity is authorized to access the network. It is to be understood, however, that any suitable mechanism for determining whether an entity is authorized to access an internal network can be utilized in connection with the present invention.

If an entity is determined be authorized to access the internal network, resources within the network can be restricted according to an identity of the entity. For example, an entity can be associated with a particular role in a company (e.g., payroll). After it has been determined that the entity is authorized to access the network, the entity can be restricted to accessing resources on the network related to payroll. Such restriction can in effect generate a virtual network, wherein such virtual network is a network comprising only resources that are pertinent to the entity. This mitigates problems that can arise when a malicious user exists within an internal network, as the malicious user will not have access to sensitive information that can compromise the network. Furthermore, scanning worms will not have an ability to corrupt an entire network, as security of the present invention limits resources that a scanning worm could reach.

In accordance with one particular aspect of the present invention, switch-based access controls can be employed to restrict an entity's access to a portion of an internal network that is pertinent to the entity. More particularly, one or more entity-specific Access Control Lists (ACLs) can be loaded into a switch that is related to the entity. ACLs can include a list of services available on a network and/or server, and can further include hosts (entities) that are permitted to use each service. After the ACL is loaded into the switch related to the entity, a port that allows the entity to obtain access to a particular portion of the network germane to entity tasks is opened. Thus, entity-specific ACLs can be generated and utilized in connection with a switch to create virtual networks (e.g., a portion of a network that is accessible to a particular entity).

Benefits of the present invention can be better understood when compared to conventional security measures for internal networks. For example, firewalls can restrict access of an entity to a particular portion of a network. Installing multiple firewalls for disparate users/groups, however, can be extremely expensive. Further, firewalls do not address concerns about unauthorized users entering an internal network prior to reaching the firewall. The present invention can employ switches that connect directly to clients; therefore, client-to-client interaction can be prevented. In contrast, firewalls cannot prevent client-to-client interaction before such firewall. Therefore, illegal sharing of copyrighted works, for instance, can occur when utilizing firewalls.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a system that facilitates securing an internal network from internal attacks in accordance with an aspect of the present invention.

FIG. 2 is another block diagram of a system that facilitates securing an internal network from internal attacks in accordance with an aspect of the present invention.

FIG. 3 is yet another block diagram of a system that facilitates securing an internal network from internal attacks in accordance with an aspect of the present invention.

FIG. 4 is still yet another block diagram of a system that facilitates securing an internal network from internal attacks in accordance with an aspect of the present invention.

FIG. 5 is another block diagram of a system that facilitates securing an internal network from internal attacks in accordance with an aspect of the present invention.

FIG. 6 is a flow diagram of a method for providing multi-layer security for an internal network in accordance with an aspect of the present invention.

FIG. 7 is a flow diagram of a method for providing multi-layer security for an internal network in accordance with an aspect of the present invention.

FIG. 8 is a flow diagram of a method for providing multi-layer security for an internal network in accordance with an aspect of the present invention.

FIG. 9 is an exemplary embodiment illustrating benefits related to one or more aspects of the present invention.

FIG. 10 is a system and methodology that illustrates one particular embodiment of providing multi-layered security against internal attacks in an internal network.

FIG. 11 is a system that facilitates authentication with respect to a user obtaining access to an internal network in accordance with an aspect of the present invention.

FIG. 12 illustrates an example-operating environment in which the present invention can function.

FIG. 13 illustrates another example operating environment in which the present invention can function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

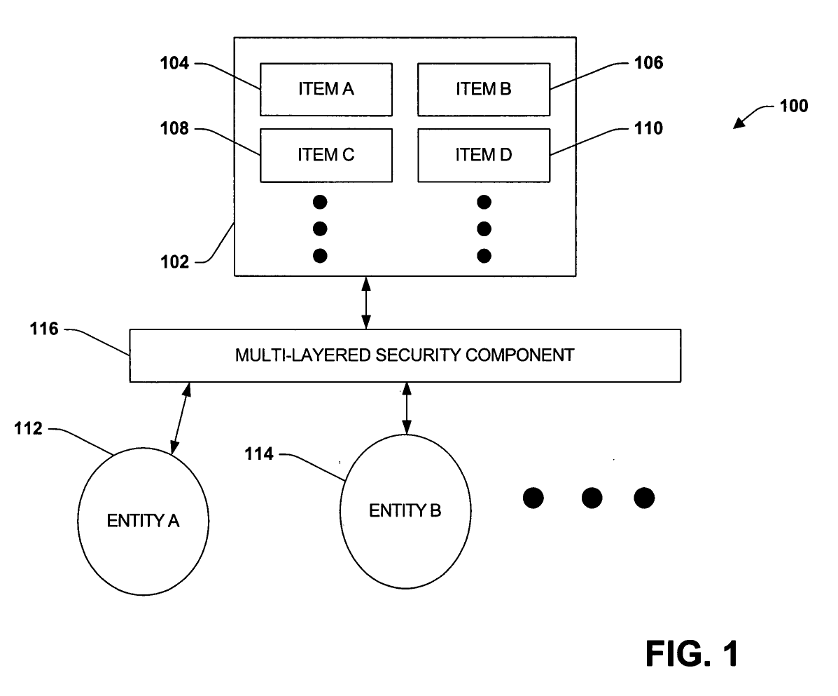

Turning now to FIG. 1, a system 100 that facilitates robust protection of an internal network from internal attacks is illustrated. The system 100 includes a collection 102 of network items 104-110 that are related to particular tasks, departments, roles, individuals, and/or other similar groups within an organization (e.g., a business, non-profit organization, . . . ). For instance, item A 104 can be related to payroll, item B 106 can be related to an engineering project, item C 108 can be related to human resources, and item D 110 can be related to a particular business strategy. It is to be understood, however, that the items 104-110 can be related to any suitable grouping within an organization. Furthermore, the items 104-110 can be any suitable items within a network (e.g., a server, an Internet proxy, . . . ). Entities A and B 112-114 are entities that desire internal access to the collection 102 of items via an internal network. For example, the entities 112-114 can be employees, programs, or other internal entities that desire access to the collection 102 of network items. While only entities A and B 112-114 are illustrated, it is to be understood that any suitable number of entities can desire access to the collection 102 of network items via the internal network.

As illustrated in this Figure, the entities 112-114 desire access to one or more items 104-110 within the collection 102. A multi-layered security component 116 is provided to ensure that the entities 112-114 are authorized to be on the network as well as provide the entities 112-114 with access only to an item corresponding to such entities 112-114. For example, entity A 112 should be given access only to item A, rather than all the items 104-110 within the collection 102. In accordance with one aspect of the present invention, the multi-layered security component 116 can utilize 802.1x, a published standard for port-based network access control. 802.1x provides authentication to devices attached to a LAN port, establishing a point-to-point connection or preventing access from that port if authentication fails. While 802.1x has become the standard for regulating access in wireless environments, 802.1x can also be employed in wired environments. For example, 802.1x can employ the Extensible Authentication Protocol (EAP) to provide authentication of one or more of the entities 112-114 that desire to access the collection 102 via an internal network. EAP is a general protocol for authentication that also supports multiple authentication methods, such as token cards, Kerberos, one-time passwords, certificates, public key authentication and smart cards. Furthermore, 802.1x can utilize authentication algorithms such as Protected Extensible Authentication Protocol (PEAP), Lightweight Extensible Authentication Protocol (LEAP), and other similar protocols employed in connection with authenticating that the entities 112-114 are authorized to access the items 104-110 within the collection 102 via the network. For instance, PEAP could be employed when authentication data (e.g., user names, passwords, . . . ) is utilized within a wireless internal network. PEAP authenticates wireless LAN clients using only server-side digital certificates via creating an encrypted SSL/TLS tunnel between the entities 112-114 and an authentication server (not shown). The tunnel thereafter protects user authentication exchange. It is to be appreciated that although specific protocols (e.g., 802.1x, EAP . . . ) are described herein in connection with various aspects of the invention, any suitable protocols for carrying out the various functionalities of the claimed invention can be employed, and employment of such protocols are intended to fall within the scope of the claims of this application.

Upon determining that entity A 112 is authorized to access the data store 102 via the internal network, the multi-layered security component 116 determines which item within the collection 102 the entity 112 is entitled to access. For example, entity A 112 is entitled to access item A 104, and entity B 114 is entitled to access item B 106. Continuing with this example, the multi-layered security component 116 provides entity A 112 with access to item A 104, but to no other items within the collection 102. Thus, item B, item C, item D, and other items within the data store 102 are secure against attacks from entity A. Likewise, after determining that entity B 114 is authorized to access the collection 102 via an internal network, the multi-layered security component 116 can provide entity B 114 with access to item B 106 and only data set B. In accordance with one aspect of the present invention, access-based switch controls can be employed to restrict access of the entities 112-114 to the items A and B 104-106, respectively. More particularly, the multi-layered security component 116 can employ custom switch level access controls for each entity 112-114. For instance, after the multi-layered security component 116 authorizes the entity 112, an Access Control List (ACL) specific to the entity 112 can be loaded into a switch that provides access to item A 104 (and not other items within the collection 102). An ACL is a set of data that informs a computer's operating system of which permissions or access rights that the entity 112 has to an internal network. Employing an entity-specific ACL in connection with a switch ensures that the entities 112-114 will only be granted access to items within the collection 102 of network items with which they have been granted permission. It is to be understood that the ACL's can be defined in numerous manners. For example, ACL's can be defined by roles (e.g., engineers, maintenance, . . . ), function, groups, individually, etc. More particularly, if the ACL's were defined by role, access to data sets would only be allowed to entities that require such data sets to perform their role.

The system 100 would provide a plurality of benefits over conventional security systems for internal networks. In particular, the system 100 minimizes spreading of worms (e.g., NIMDA, scanning worms, . . . ). This is because flow of data is highly restricted within the internal network. Thus, a worm can be isolated to a particular item within the internal network and be unable to reach other items. Furthermore, the present invention can be employed to mitigate illegal file trading (e.g., copying and dissemination of copyrighted works), as internal networks typically operate in a client-to-server fashion. Similarly, the system 100 can prevent unauthorized server services from being accessed on a client, as well as protect clients from port scanning other clients. Moreover, if an internal network employs the Simple Network Management Protocol or other substantially similar protocol, scanning or traffic issues (heavy port traffic, blocked port traffic) can be located early and an appropriate technician can be notified.

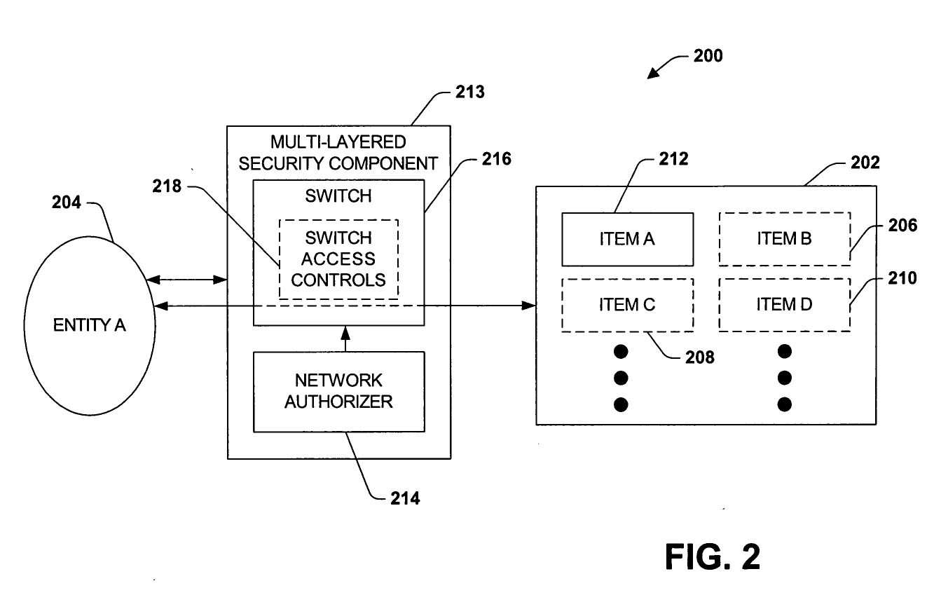

Now referring to FIG. 2, a system 200 that facilitates securing an internal network from internal attacks is illustrated. The system 200 includes a collection 202 of network items that are utilized in connection with an internal network. An entity 204 desires access to the collection 202 via the internal network, and more particularly desires to maliciously attack items B, C, and D 206-210 that are within the collection 202. The entity A 204, however, only has privileges to access item A 212. For example, the entity A 204 can be associated with a particular role within an organization, and item A 212 is the only item that the entity A 204 requires to perform the role. A multi-layered security component 213 is employed to maintain security of an internal network (and thus of the collection 202 of network items that at least partially make up the network). The multi-layered security component includes a network authorizer 214 that determines that the entity A 204 is allowed to access the collection 202. For example, the network authorizer 214 can utilize any suitable conventional standard that verifies that an entity is authorized to access a network. In accordance with one particular aspect of the present invention, the network authorizer 214 can employ the 802.1x standard to authenticate that the entity A 204 is authorized to access the collection 202 via an internal network. In an environment that the 802.1x standard is implemented, the entity A 204 will be unable to transmit any traffic via the network until such entity A 204 has been authenticated. Furthermore, implementing the present invention utilizing the 802.1x standard will be efficient and low-cost, as virtually all operating systems provide support for 802.1x, and the authentication process is transparent to an end user.

The system 200 further comprises a switch 216 that is employed to enable access of particular items to the entity A 204. For example, if item A 212 is a server, the switch 216 can be employed to enable entity A 204 to obtain access to that server and no other servers on the internal network. This can be accomplished via providing the switch 216 with switch access controls 218 that are generated based upon an Access Control List that is specific to the entity A 204. The switch 216 and the switch access controls 218 ensure that the entity A 204 will be granted access only to servers that it has permission to access. After determining a level of access that the entity A 204 has to the collection 202 of network items, the entity A 204 can access one or more items that it has permission to access via the switch 216.

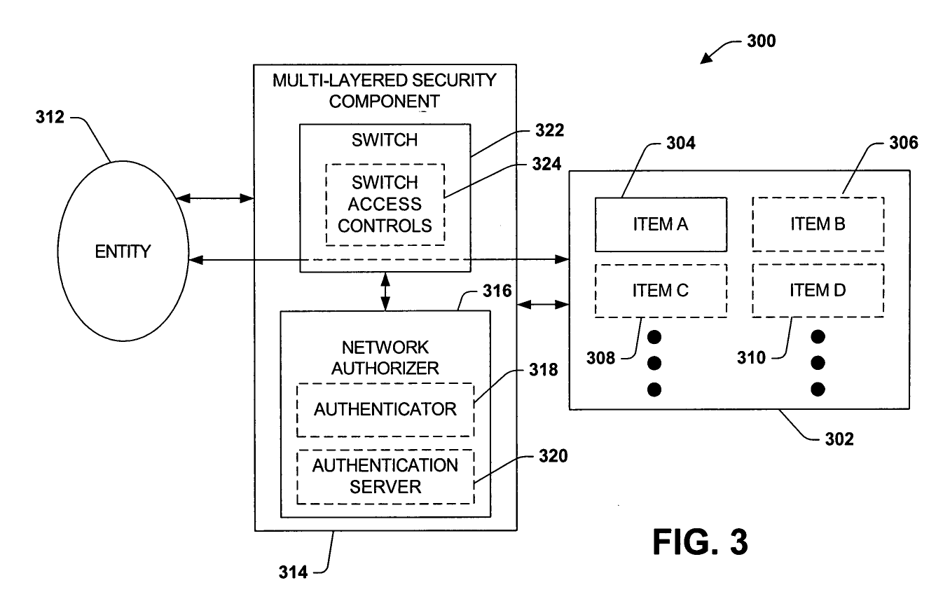

Now turning to FIG. 3, a system 300 that facilitates securing an internal network from internal attacks is illustrated. The system 300 includes a collection 302 of network items (e.g., servers, Internet proxies, . . . ) that are employed within an internal network. More particularly, the collection 302 of network items includes item A 304, item B 306, item C 308, and item D 310. While the collection 302 is shown to include four network items, it is to be understood that the collection 302 can include any suitable number of network items. Furthermore, the network items 304-310 can be associated with particular roles. For example, item A 304 can be associated with payroll, item B can be associated with accounting, etc. The system 300 includes an entity 312 that has been assigned a set of permissions pertaining to which items within the collection 302 the entity 312 can access. In accordance with one aspect of the present invention, the entity 312 can be a user. Furthermore, the entity 312 can be a program that desires access to one or more network items 304-310.

The entity 312 desires access to the collection 302 of network items via an internal network. Thus, the entity 312 can attempt to request access to one or more particular items within the collection 302 of network items via the network. A multi-layered security component 314 receives the request to access the internal network (and to access one or more items 304-310). The multi-layered security component 314 ensures that the entity 312 is authorized to be on the internal network, and if so determines which items 304-310 the entity 312 has permission to access. More particularly, the multi-layered security component 314 includes a network authorizer 316 that determines whether the entity 312 is allowed to be on the internal network. In accordance with one aspect of the present invention, the network authorizer 316 utilizes the 802.1x standard to make such determination. Typically, the authentication process of the 802.1x standard has three disparate components: the entity 312 (client), an authenticator 318 (typically a switch or access point), and an authentication server 320. In accordance with one aspect of the present invention, the authentication server 320 can be a Remote Access Dial-in User Services (RADIUS) server. RADIUS systems can employ a plurality of authentication schemes, such as Password Authentication Protocol (PAP) and Challenge-Handshake Authentication Protocol (CHAP). Furthermore, the authentication server 320 can be a Terminal Access Controller Access Control System (TACACS) server, an Extended TACACS server, a TACACS+ server, and/or any other suitable authentication server.

The entity (client) 312, the authenticator 318, and the authentication sever 320 interact in the following manner—first, the entity 312 attempts to enter an internal network. The authenticator 318 then requests that the entity 312 provide identification. The entity 312 thereafter provides its identification to the authenticator 318, which passes the ID onto the authentication server 320. If the identification is valid, the authentication server 320 then informs the authenticator 318 that a password is desired, and the authenticator 318 passes this to the entity 312. The entity 312 responds with a password that corresponds to the identification, which is delivered to the authentication server 320. The authentication server 320 thereafter informs the authenticator 318 whether the user password was correct. If the password is not correct, the entity 312 will be denied access to the internal network (and thus to the collection 302 of network items). If the password is correct, a switch 322 is provided to allow the entity 312 to obtain access to an item that corresponds with permissions assigned to the entity 312. The switch 322 utilizes switch access controls 324 to determine which item(s) are accessible by the entity 312. In one example, the entity 312 has permission to access only item A 304 from the collection 302 of internal network items. Thus item A (and contents thereof) can be accessed by the entity 312 via the switch 322 while remaining items within the collection 302 (items B, C, and D) will not be accessible by the entity 312. However, it is to be understood that the present invention contemplates an entity having permission to access more than one item from the collection 302 of items (e.g., items A, B, and D but not C).

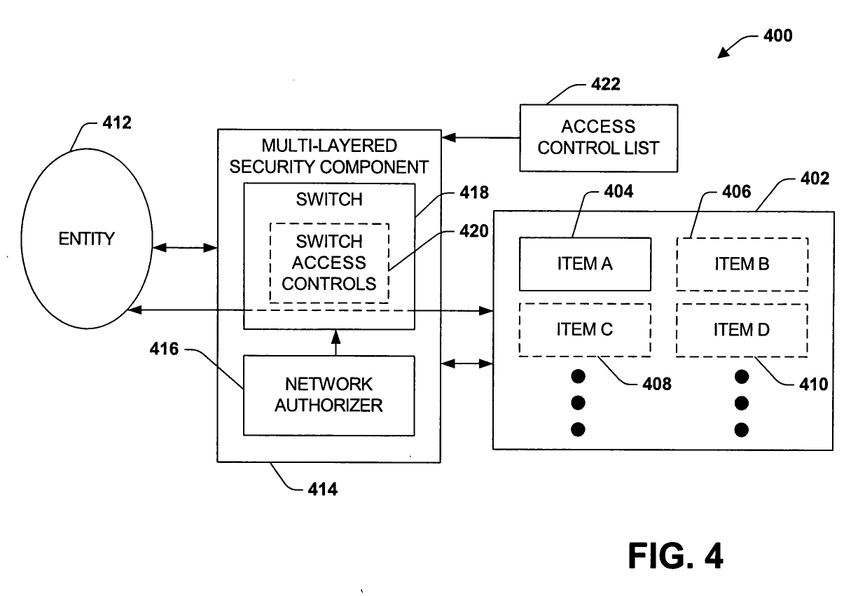

Now referring to FIG. 4, a system 400 that reduces risk of internal attack within an internal network is illustrated. The system 400 includes a collection 402 of internal network items 404-410 that can be accessed by an entity 412 via an internal network. Furthermore, the collection 402 can be accessed by a plurality of other entities (not shown) that are connected to the internal network. More particularly, in a business setting each client can be have access to the internal network. A multi-layered security component 414 is provided to ensure that the entity 412 is authorized to access the collection 402, and to further limit the entity's access to the collection 402 based upon pre-determined permissions. For instance, the entity 412 can be within a particular department of an organization, wherein members of that department only utilize item A 404 (or data thereon) to complete tasks assigned to that department. Thus, the multi-layered security component 414 can effectively limit the entity's access to only item A 404 (and not item B 406, item C 408, . . . ).

The multi-layered security component 414 accomplishes this task by employing a network authorizer 416 to determine whether the entity 412 is approved to be on the internal network. For instance, the network authorizer 416 can utilize an authentication server or the like in connection with user names and passwords to determine whether the entity 412 should have access to the internal network (and thus have access to one or more of the items 404-410). The multi-layered security component 414 also utilizes a switch 418 to filter and forward data packets between the entity 412 and the collection 402. More particularly, the switch 418 is generated to allow the entity 412 to access only item(s) within the collection 402 that the entity 412 has permission to access. The switch 418 can prevent delivery of data packets generated by the entity 412 from reaching an item (e.g., items 406-410) that the entity 412 does not have permission to access. Likewise, the switch 418 can prevent the entity 412 from receiving data from items that the entity 412 does not have permission to access. Permissions relating to the entity 412 are generated based at least in part upon switch access controls 420 that employ an access control list 422 specific to the entity 412. The access control list 422 is essentially a list of items and computing services available within the collection 402 that the entity 412 has been granted permission to access. Based upon this access control list 422 the switch access controls 420 can be generated, which control the operation of the switch 418. In accordance with one aspect of the present invention, the access control list 422 can be configured at the switch level without being vendor specific, thereby creating a robust and efficient security device. Furthermore, the access control list 422 can be interoperable with existing account databases (Active Directory, LDAP, . . . ). Moreover, the access control list 422 can account for point-of-access when determining which permissions to assign to the entity 412. For instance, the access control list 422 will include different criteria as a user's geographic location changes (and thus the switch access controls 420 will be different when the user's geographic location changes). Therefore the system 400 provides location aware authentication and an ability to pinpoint a physical location where access is occurring. The system 400 also provides for an efficient means for logging and auditing all access requests, not only for the entire network but also for particular items within the internal network. Furthermore, unauthorized network mapping can be mitigated utilizing the present invention, and an increase in available network bandwidth will result from employing one or more aspects of the present invention.

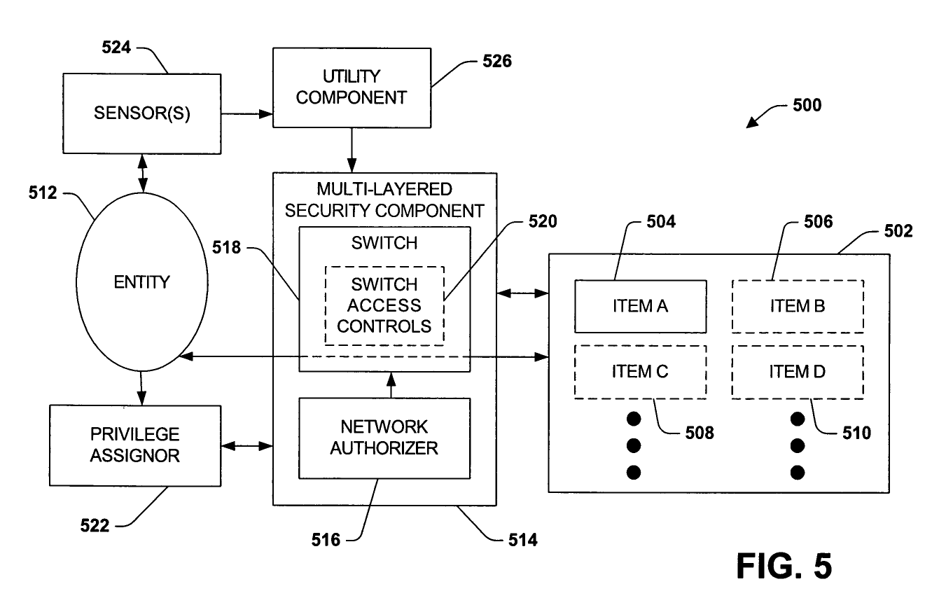

Now referring to FIG. 5, a system 500 that facilitates securing an internal network from internal attacks is illustrated. The system 500 includes a collection 502 of internal network items 504-510 that are within and/or at least partially create an internal network for an organization. An entity 512 desires access to at least one of the items 504-510 within the collection 502. The entity can be a user operating on a client, a program that automatically requests access to the collection 502, etc. A multi-layered security component 514 is employed by the system 500 to ensure that the internal network is secure in light of requests to access such network (e.g., requests for items within the collection 502). The multi-layered security component 514 includes a network authorizer 516 that ensures that the entity 512 should be on the internal network. For instance, a salesman that is selling within an organization should not be allowed access to the network in general, and the network authorizer 516 would prevent such salesman from obtaining access. For example, the 802.1x standard can be employed to ensure that unauthorized users are denied access to the internal network (and thus denied access to the items 504-510). If the entity 512 is allowed access to the internal network, the network authorizer 516 informs a switch 518, and the switch 518 grants the entity access to the collection 502 based upon permissions. For instance, permissions can be assigned based upon a role, a function, a group, or other suitable organizational indicia. More particularly, the entity can be associated with a payroll function in a business, and item A 504 is the sole item within the collection 502 that is related to payroll. The switch 518 then is employed to filter communications between the entity 512 and the collection 502 to effectuate communication only between the entity 512 and item A 504. The switch 518 is associated with switch access controls 520 that control operation of the switch 518 given a particular entity and collection of internal network items.

The system 500 further includes a data privilege assignor 522 that determines rights the entity 512 can utilize with respect to the item(s) within the collection 502 that the switch 518 grants the entity 512 access. For example, the switch 518 can operate to provide the entity 512 with access only to item A 504. The data privilege assignor 522 determines rights the entity 512 can employ with respect to data transferred to and/or from item A 504. More particularly, item A 504 can be a server with a data store. The switch 518 can grant the entity 512 access to such server, and the data privilege assignor 522 can assign rights to the item with respect to read operations, write operations, etc, and various other privileges of the entity 512. More particularly, it may be desirable to allow the entity 512 to access item A 504, but with read-only privileges. For instance, a salesman not employed by an organization might desire to obtain inventory information, but it would not be safe to allow the salesman to alter the inventory information (e.g., the salesman could alter numbers to make it appear that more equipment is required). Thus, the data privilege assignor 522 can be employed to assign privileges with respect to data relating to items in the collection 502. For example, read only, read/write, write only and other similar privileges can be assigned via the data privilege assignor 522. Furthermore, the data privilege assignor 522 can operate in connection with sensor(s) 524 and a utility component 526 to assign privileges to the entity 512. For instance, it may be desirable to assign disparate data privileges to the entity at different times or when the entity 512 is in disparate geographic locations. Sensor(s) (e.g., GPS, location identifier on a client, . . . ) can determine the geographic location, and the data privilege assignor 522 can employ such information to determine privileges to assign to the entity 512 with respect to particular items.

Furthermore, the utility component 526 can be employed to complete a cost-benefit analysis in connection with assigning appropriate data privileges to the entity 512 with respect to particular items that the entity 512 has access to as determined by the switch 518. For instance, the utility component 526 can weigh costs of assigning incorrect user privileges (e.g., privileges that are too limiting) against benefits of assigning correct privileges given a probability of correctness, user state and context, historical data, etc. Furthermore, the utility component 526 can operate in connection with the switch 518 to infer which items the entity 512 should have access to given a user state and context.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject invention.

Thus, for instance, the utility component 526 can make inferences regarding whether to allow the entity 512 access to one or more items within the collection 502. In a particular example, a president of an organization typically will have complete access to all items on an internal network (e.g., all items 504-510 within the collection 502). In certain instances, however, it may be to the detriment of the internal network to allow such broad access. For instance, in a time where the network can be compromised by a plurality of viruses, it may be desirable to restrict access to a small number of items. Furthermore, bandwidth can be utilized more efficiently when access is granted only to items that a user requires to complete a task. The utility component 526 can watch users and learn over time their tendencies in connection with accessing items within the collection 502. For instance, a user with access to numerous items may only utilize one item during particular times of the day. Thus, the utility component 526 can learn tendencies to make the system 500 more efficient and secure.

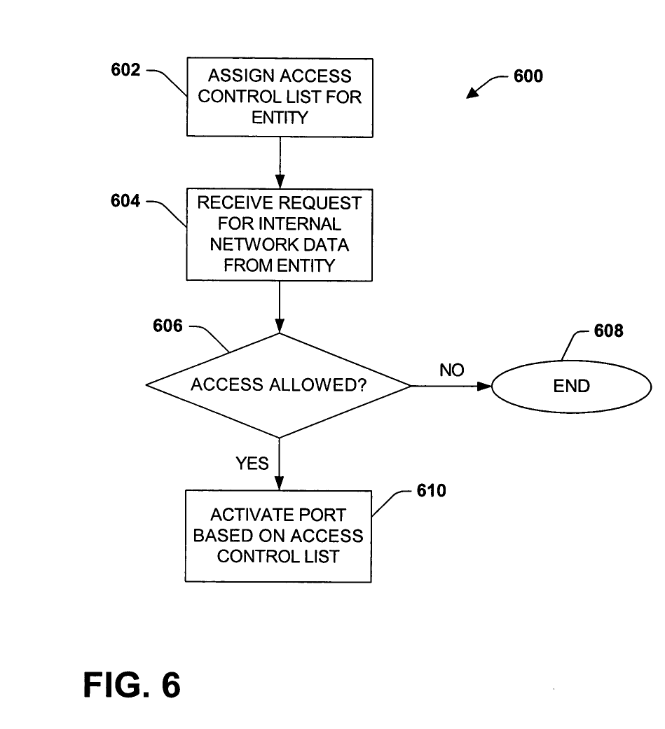

Referring now to FIG. 6, a methodology 600 for securing an internal network against internal attacks is illustrated. While, for purposes of simplicity of explanation, the methodology 600 is shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

At 602, an access control list for a particular entity is generated. In accordance with one aspect of the present invention, the entity can be a user or group of users (e.g., users who work in a particular department of an organization). Thus, for example, employees in payroll would have substantially similar access control lists. Furthermore, access control lists can be generated per individual, wherein each individual is given access to items within a network that are utilized in connection with their employment. Access control lists are employed in connection with network switches, and are utilized to maintain security of an internal network against internal attacks.

At 604, a request for data and/or items on the network is received from the entity. For example, information can be requested from a particular server within an internal network (e.g., a server dedicated to a particular department in the organization). The request could simply be a user turning on a computer device, wherein the device automatically attempts to connect to the network. Alternatively, a particular computer program could request access to the network to complete a pre-defined task that requires particular data that resides within the network.

At 606, a determination is made regarding whether the entity is authorized to access the network. Any suitable authorization mechanism can be employed to determine whether the entity is authorized to access the network. In accordance with one aspect of the present invention, the standard 802.1x is utilized to enforce authorized use of the internal network. For instance, an authentication server can be provided together with an authenticator to facilitate the determination of whether the entity is authorized to access the network. More particularly, user identification and passwords can be relayed between a client that the entity is utilizing, the authenticator, and the authentication server. Furthermore, in accordance with one aspect of the present invention the authentication server is a RADIUS server. If the entity does not have rights to access the network, the methodology ends at 608.

If access is allowed, at 610 the port is activated based upon the access control list for the entity. For example, a switch that the access control list is associated with can limit the entity's access to items and/or data on the network that the entity utilizes in connection with a job function. Thus, a user in a first department in an organization (e.g., business) will not be granted access to data that is not related to the first department but rather is related to a second department within the organization. The methodology 600 thus effectively mitigates occurrences of malicious internal attacks on a network. For example, if an internal attack affected a particular item on the network, rather than interrogate everyone on such network the attacker could be located via reviewing those that had privileges to access the item.

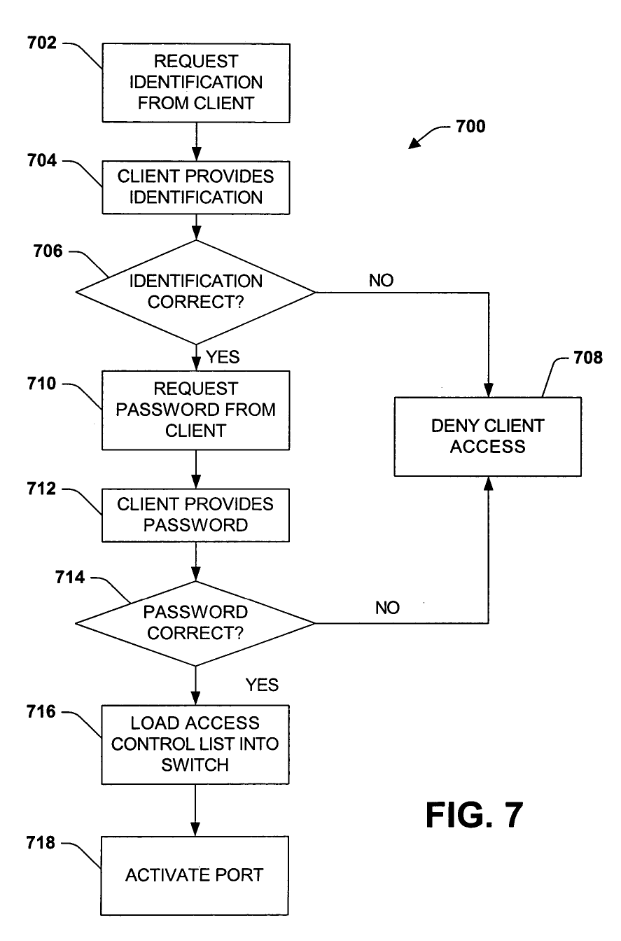

Now turning to FIG. 7, a methodology 700 for securing a network against internal attacks is illustrated. The methodology 700 is described with respect to the 802.1x authentication standard—however, it is to be understood that any suitable authentication standard can be employed in connection with the present invention. At 702 identification information is requested from a client that desires to obtain access to a network. A switch or access point (e.g., an authenticator) delivers the identification request to the client (e.g., a particular computer that a specific user is utilizing to access the network). At 704 the client provides the identification requested by the authenticator. Such identification information can then be relayed to an authentication server for analysis. In accordance with one aspect of the present invention, authentication protocols such as PEOP, LEAP, PAP and other suitable protocols can be employed in connection with communication of identification information and passwords. Furthermore, the authentication server can be a RADIUS server, A TACACS server, an XTACAS server, a TACAS+ server, or other suitable server. At 706 a determination is made regarding whether the identification is correct. For example, the determination can be made at an authentication server. If the given identification is not correct, access is denied to the client at 708, and the only information that can be relayed and/or received by the client is 802.1x data.

If the identification is correct, then at 710 a password is requested from the client. The password request can originate from the authentication server after it has authenticated the identification given by the client. The authenticator can then receive the password request and relay it to the client. At 712 the client provides the requested password, which is delivered to the authenticator and relayed to the authentication server. Thereafter at 714 a determination is made regarding whether the password given by the client is correct. If the password is not recognized and/or is not correct, access to the network is denied to the client at 708. If the password is correct, an access control list is loaded into a switch at 716. In accordance with one aspect of the present invention, the access control list is utilized as a permission system that can grant particular access levels to disparate sources. Thus, the switch in connection with the access control list can be employed to grant the client access to a portion of the network that is relevant to a function, role, group, etc. that the user utilizing the client is involved with. After the access control list is loaded into the switch, at 718 the port between the client and a server containing desirable information is activated. Thus, the client can obtain information relevant to the user, but cannot obtain and/or compromise information/data/items that are not related to the user.

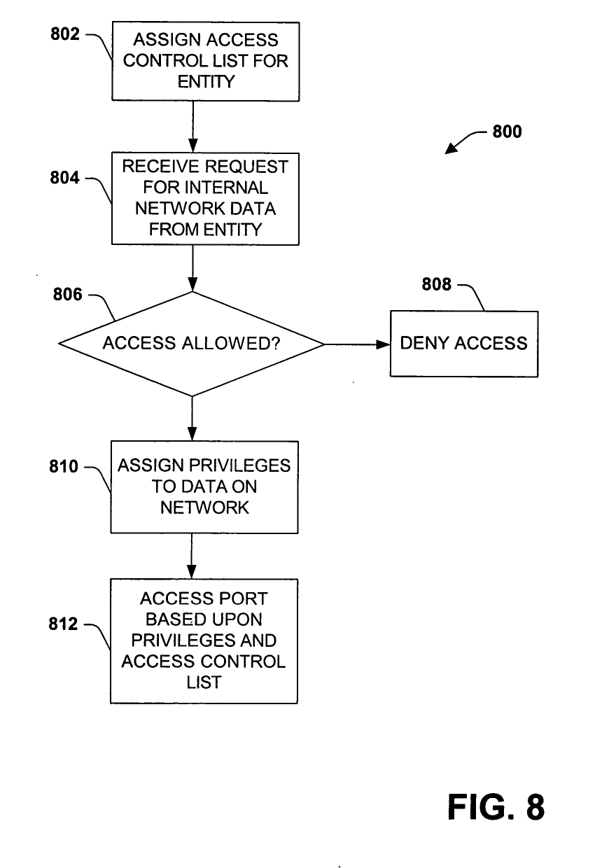

Now referring to FIG. 8, a methodology that facilitates mitigating occurrences of internal attacks on a network is illustrated. At 802 an access control list is assigned to a particular entity. The access control list is employed to control a switch, wherein the access control list is a permission system utilized to grant an entity a level of access to resources on the network. Furthermore, different access control lists can have disparate levels of permission. For example, an access control list related to a president of an organization would be associated with more permissions than an access control list related to an office assistant.

At 804, an internal request for network data by an entity (e.g., client, user, program, . . . ) is received. At 806 a determination is made regarding whether the entity is allowed access to the network. In accordance with one aspect of the present invention, an authentication server and a switch and/or point of access are utilized in connection with determining whether the entity is authorized access to the network. Furthermore, various protocols can be employed in connection with transferring authentication data between the entity and the authentication server/switch/point of access. If it is determined that access is not allowed, then access is denied at 808.

If the entity is authorized to access the network, at 810 privileges are assigned to data resident on the network according to the entity that has access to the network. For example, a particular entity may be assigned read-only privileges to particular data on the network even though the entity is allowed access to such network. Similarly, read/write, write-only, and other suitable privileges can be assigned to data resident upon the network with respect to a particular entity that is accessing such data. In accordance with another aspect of the present invention, contextual information (user state, user context, time, point of entry, . . . ) can be utilized to determine a level of privileges to assign to data on the network.

At 812, a port between the entity and desired item is activated based upon the access control list for the entity as well as the assigned privileges. For example, a switch that the access control list is associated with can limit the entity's access to items and/or data on the network that the entity utilizes in connection with a job function. Further, the privileges can determine whether and/or how data related to the item can be modified. The methodology 800 thus effectively mitigates occurrences of malicious internal attacks on a network, and further addresses concerns regarding modification of data related to accessed items.

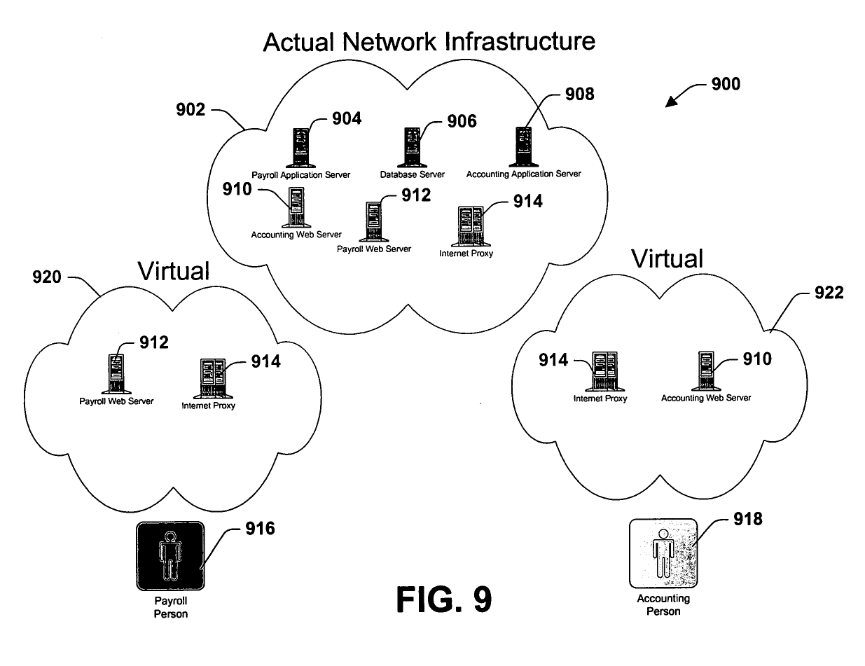

Now turning to FIG. 9, an exemplary embodiment 900 that illustrates one or more benefits of the present invention is illustrated. The embodiment illustrates a network infrastructure 902, wherein the infrastructure comprises a payroll application server 904, a database server 906, an accounting application server 908, an accounting web server 910, a payroll web server 912, and an Internet proxy 914. The embodiment 900 further illustrates two disparate users: a payroll person 916 and an accounting person 918. In conventional internal network security systems, once a user gained access to the network infrastructure, such user would have access to all of the items 904-914 within the infrastructure. This is problematic, as the accounting person 918 does not need to obtain access to the payroll web server 912. Furthermore, sensitive servers (e.g., servers 904-908) should not be accessible by the payroll person 916 nor the accounting person 918.

Utilizing the multi-layered security concept of the present invention, the payroll person 916 has access to a virtual network that only includes items that are related to their role within an organization. More particularly, the payroll web server 912 and the internet proxy 914 are accessible by the payroll person 916, while other items not germane to the function of the payroll person 916 are not available to such payroll person 916. Similarly, a virtual network 922 is created for the accounting person 918, wherein such accounting person only can obtain access to items required for accounting tasks (e.g., the accounting web server 910 and the internet proxy 914). Thus, the multi-layered security concept provides for robust security against internal attacks against the network infrastructure 902.

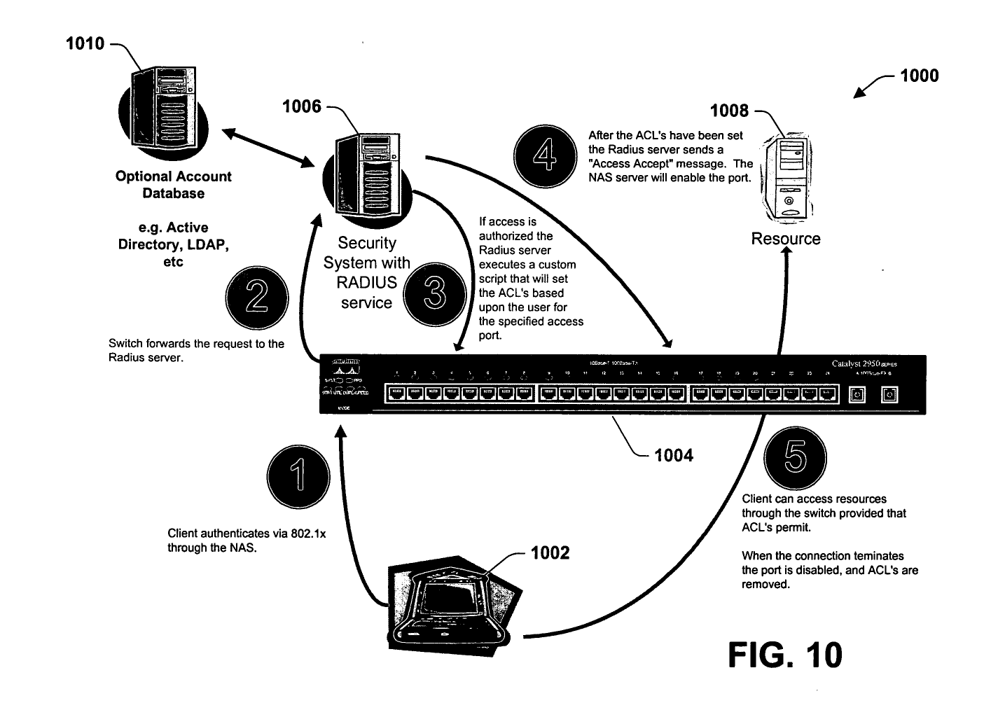

Now referring to FIG. 10, a system and methodology 1000 in accordance with one particular implementation of the present invention is illustrated. According to Act 1, a client 1002 delivers authentication information via 802.1x to a Network Attached Storage (NAS) server 1004. The NAS server includes a switch, and such switch relays a request for access to the network to a RADIUS server 1006 at Act 2. At Act 3, if access is authorized the RADIUS server 1006 will execute a script that sets access control lists based at least in part upon the user for a specific access port. At Act 4, after the access control lists have been set the RADIUS server delivers a message to the NAS server 1004 that will enable a port between the client 1002 and a desired item 1008. Thereafter at Act 5 the client 1002 can access the item 1008 through a switch, provided that the access control lists allow such access. Upon termination of the connection, the port is disabled and the access control lists are removed. The system 1000 can also include an optional account database 1010 that includes Active Directory®, which allows administrators to assign policies to workstations, deploy programs to many computers, and apply critical updates to an entire organization. Active Directory® also stores information about its users and can act in a similar manner to a phone book. This allows all of the information and computer settings about an organization to be stored in a central, organized database. Furthermore the optional account data base 1010 can utilize Lightweight Directory Access Protocol (LDAP) or other suitable protocol to access information from a directory.

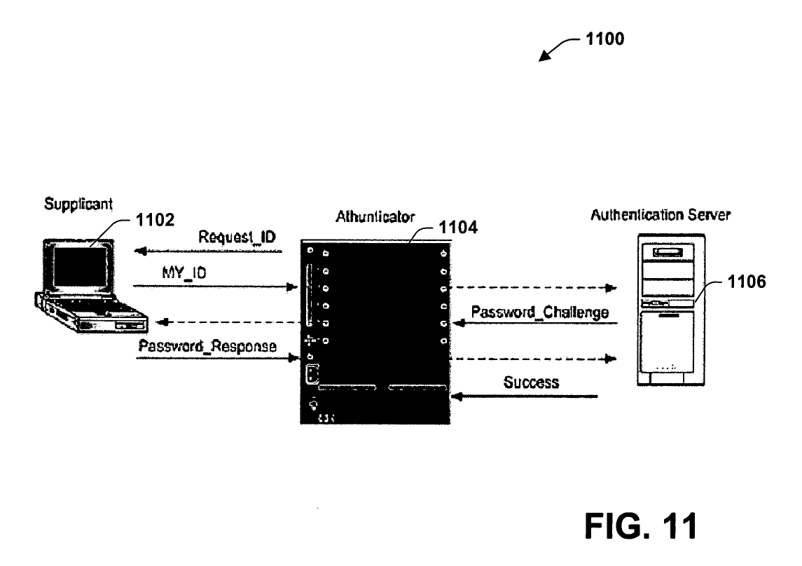

Now turning to FIG. 11, a system 1100 for authenticating that a supplicant 1102 is authorized to access resources on a network is illustrated. The system 1100 includes an authenticator 1104 that facilitates determining whether the supplicant 1102 is authorized to access an internal network. In accordance with one aspect of the present invention, the authenticator 1104 can be a NAS server that includes one or more switches and/or points of access. Furthermore, the switch provided in the NAS server can be associated with a plurality of access control lists that inform the switch regarding how to operate with respect to the supplicant 1102 and a resource (not shown) desirably accessed by the supplicant 1102. The authenticator 1104 requests an ID from the supplicant 1102, and according to that request a user associated with the supplicant 1102 can provide an identification that enables access to the network. The identification given by the supplicant 1102 is delivered to an authentication server 1106 via the switch. In accordance with one aspect of the present invention, the authentication server 1106 can be a RADIUS server. If the identification is valid, then the authentication server 1106 requests a password from the supplicant 1102 via the switch in the authenticator 1104. The supplicant 1102 thereafter responds to the request with a password, which is again delivered to the authentication server 1106 via the switch. The authentication server 1106 then informs the authenticator 1104 that the supplicant 1102 is authorized to access the network. While not shown, control access lists can then be employed in connection with the switch to create a virtual network for the supplicant 1102, similar to those shown with respect to FIG. 9.

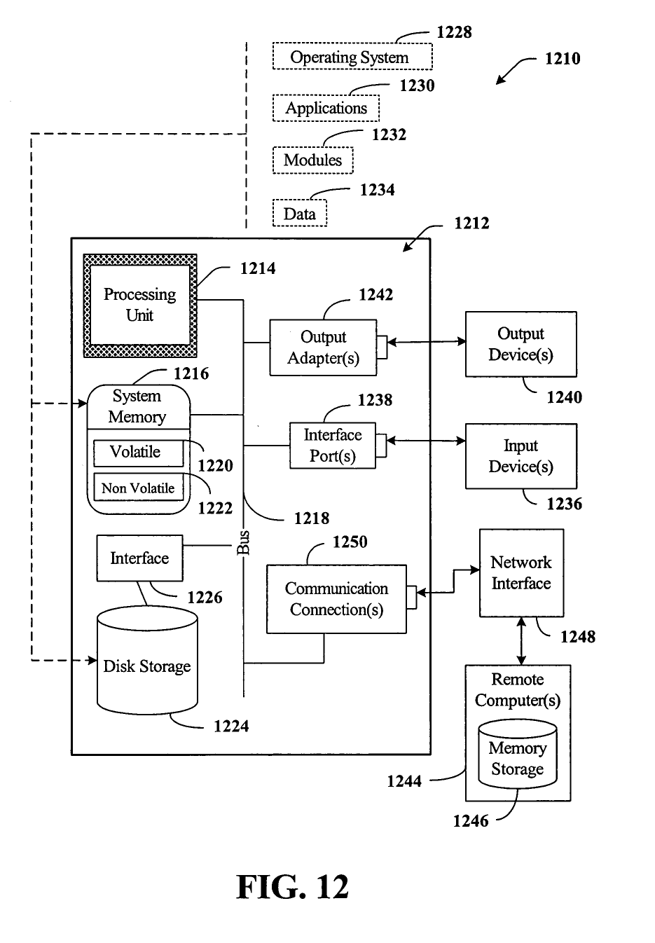

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the present invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

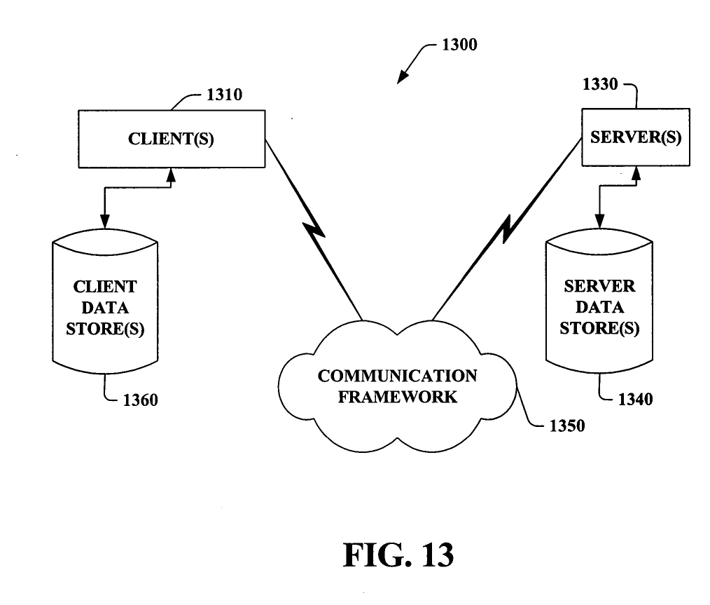

FIG. 13 is a schematic block diagram of a sample-computing environment 1300 with which the present invention can interact. The system 1300 includes one or more client(s) 1310. The client(s) 1310 can be hardware and/or software (e.g., threads, processes, computing devices). The system 1300 also includes one or more server(s) 1330. The server(s) 1330 can also be hardware and/or software (e.g., threads, processes, computing devices). The servers 1330 can house threads to perform transformations by employing the present invention, for example. One possible communication between a client 1310 and a server 1330 can be in the form of a data packet adapted to be transmitted between two or more computer processes. The system 1300 includes a communication framework 1350 that can be employed to facilitate communications between the client(s) 1310 and the server(s) 1330. The client(s) 1310 are operably connected to one or more client data store(s) 1360 that can be employed to store information local to the client(s) 1310. Similarly, the server(s) 1330 are operably connected to one or more server data store(s) 1340 that can be employed to store information local to the servers 1330.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates protecting an internal network from internal attacks, comprising:
a component that receives a request to access the internal network, the internal network including a plurality of items; and
a multi-layered security component that determines that an entity that delivers the request is authorized to access the internal network, and restricts access of the entity to a subset of the items.

2. The system of claim 1, the multi-layered security component comprising:
a network authorizer that determines that the entity is authorized to access the internal network; and
a switch that is controlled by switch access controls, the switch facilitates restricting access to the entity to a subset of the items.

3. The system of claim 2, the network authorizer employs an 802.1x standard to determine that the entity is authorized to access the internal network.

4. The system of claim 3, the 802.1x standard utilizes an Extensible Authentication Protocol in connection with determining that the entity is authorized to access the internal network.

5. The system of claim 4, the Extensible Authentication Protocol utilizes one or more of token cards, Kerberos, one-time passwords, certificates, public key authentication and smart cards in connection with determining that the entity is authorized to access the internal network.

6. The system of claim 3, the 802.1x standard utilizes one or more of a Protected Extensible Authentication Protocol and a Lightweight Extensible Authentication Protocol.

7. The system of claim 2, the switch access controls based at least in part upon an Access Control List that is related to the entity.

8. The system of claim 7, the Access Control List defined by at least one of a group, function, and role of the entity.

9. The system of claim 7, the Access Control List is interoperable with existing account databases.

10. The system of claim 7, the Access Control List accounts for point-of-access within the internal network when determining which permissions to assign to the entity.

11. The system of claim 2, the network authorizer comprises an authenticator and an authentication server, the authenticator requests that the entity provide identification, and relays such identification to the authentication server.

12. The system of claim 11, the authentication server determines that the entity has provided an acceptable identification, and requests that the entity provide a password via the authenticator.

13. The system of claim 1, the multi-layered security component utilizes a one or more of a RADIUS server, a TACACS server, a XTACACS server, and a TACACS+ server in connection with determining that the entity is authorized to access the internal network.

14. The system of claim 13, the multi-layered security component employs one or more of a Password Authentication Protocol and a Challenge-Handshake Authentication Protocol.

15. The system of claim 1, at least one of the items is a server.

16. The system of claim 1, at least one of the items is an Internet proxy.

17. The system of claim 1, further comprising a component that defines privileges that the entity has with respect to the subset of items.

18. The system of claim 1, the multi-layered security component utilizes at least a username and a password to determine that the entity is authorized to access the internal network.

19. The system of claim 1, a user name and password communicated from a client and received by an authentication server that verifies the user name and password.

20. The system of claim 1, the internal network employs a Simple Network Management Protocol.

21. The system of claim 1, further comprising a data privilege assignor that assigns privilege levels with respect to items that the entity is authorized to access.

22. The system of claim 21, the privilege levels comprising one or more of read only privileges, write only privileges, and read and write privileges.

23. The system of claim 21, the data privilege assignor comprises a utility component that alters privilege levels assigned to the entity based at least in part upon one or more of date, time, and geographic location.

24. The system of claim 23, the utility component performing a cost/benefit analysis in connection with altering privilege levels assigned to the entity.

25. A wireless network comprising the system of claim 1.

26. A method for securing an internal network against internal attacks, comprising:
providing an internal network, the internal network comprising a plurality of network items;
assigning access rights to particular items within the internal network to an entity;
determining that the entity is authorized to access the internal network; and
allowing the entity to access the particular items on the network according to the assigned access rights.

27. The method of claim 26, further comprising generating an Access Control List for the entity, and assigning the access rights based at least in part upon the Access Control List.

28. The method of claim 26, further comprising authenticating entity identification and a password relating to the entity prior to allowing the entity to access the internal network.

29. The method of claim 26, further comprising employing an 802.1x standard in connection with determining that the entity is authorized to access the internal network.

30. The method of claim 29, further comprising providing an authentication server and an authenticator in connection with determining that the entity is authorized to access the internal network.

31. The method of claim 30, the authentication server is one of a RADIUS server, a TACACS server, a XTACACS server, and a TACACS+ server.

32. The method of claim 30, the authenticator being one of a switch and an access point.

33. The method of claim 26, further comprising loading an Access Control List into a switch in connection with assigning the entity with access rights.

34. The method of claim 33, further comprising opening a port between the entity and a server that comprises the particular items.

35. A method for mitigating internal attacks on an internal network, comprising:
assigning an Access Control List to an entity that desires access to the internal network;
receiving an internal request from the entity to access the network;
verifying that the entity is authorized to access the network;
assigning access privileges to data on the internal network based at least in part upon identification of the entity and contents of the Access Control List.

36. The method of claim 35, the access privileges being one or more of read only privileges, write only privileges, and read and write privileges.

37. The method of claim 35, further comprising loading the Access Control List into a switch upon verifying that the entity is authorized to access the network.

38. The method of claim 35, further comprising restricting the entities access to a subset of items on the internal network according to contents of the Access Control List.

39. The method of claim 35, further comprising opening a port between the entity and the subset of items based at least in part upon contents of the Access Control List.

40. The method of claim 35, further comprising assigning the access privileges to the data based at least in part upon contextual information relating to the entity.

41. A system that maintains security of an internal network, comprising:
an authentication component that verifies that an entity is authorized to access the internal network; and
a component that restricts a number of items that are accessible by the entity according to an Access Control List that is assigned to the entity.

42. The system of claim 41, the Access Control List assigned to a plurality of entities.

43. The system of claim 41, the authentication component employing an 802.1x standard in connection with verifying that the entity is authorized to access the internal network.

44. A system that facilitates maintenance of security on an internal network, comprising:
means for restricting access to the internal network to authorized entities; and
means for limiting which items on the internal network the entities are authorized to access, the means for limiting based at least in part upon Access Control Lists that are related to the entities.

45. The system of claim 44, further comprising means for assigning privileges to data resident on the internal network.
